(19) United States
(12) Patent Application Publication
(10) Pub. No.: US 2026/0237183 A1
(43) Pub. Date: Aug. 13, 2026

(54) ASSET HIERARCHY BUILDER SYSTEM USING PRELABELLED ANNOTATION, MULTI-SPECTRUM OF IMAGE AND VIDEO DATA

(71) Applicant: HITACHI VANTARA LLC, Santa Clara, CA (US)

(72) Inventors: Mauro Arduino DAMO, Windermere, FL (US); Wei LIN, Plainsboro, NJ (US); Fnu AIN-UL-AISHA, Framingham, MA (US)

(21) Appl. No.: 19/156,564

(22) PCT Filed: Feb. 27, 2023
(86) PCT No.: PCT/US2023/063357

§ 371 Date: Aug. 14, 2025

(51) Int. Cl. G06V 10/762; G06Q 40/06; G06V 10/25; G06V 10/44; G06V 10/74; G06V 10/776; G06V 20/70

(52) U.S. Cl. CPC G06V 10/7625; G06Q 40/064; G06V 10/25; G06V 10/44; G06V 10/761; G06V 10/776; G06V 20/70; G06V 2201/10

(57) ABSTRACT

Systems and methods described herein involve generating an asset hierarchy from a plurality of images of a plurality of asset, which can involve executing a machine learning process to identify the plurality of assets from the plurality of images; identifying relationships between the identified plurality of assets based on feature extraction and analysis of extracted features of the identified plurality of assets; and generating the asset hierarchy from one or more asset hierarchy templates derived from the identified relationships between the identified plurality of assets.

### BACKGROUND

### Field

The present disclosure is directed to asset management systems, and more specifically, for asset hierarchy building systems using image and video data.

### Related Art

Many industries have been in the process of digitization. However, digitization is a laborious and error prone task to create and maintain the inventory and update it with the existing assets and their components. It is a common industrial challenge due to the lack of recognized and organized asset hierarchy and component specific documentation for operations optimization. There is a need to fill this space via providing appropriate automated methodologies and processes.

In many industrial use cases in the related art, a single infrastructure component (e.g. transmission line) is spread over multiple geophysical locations, and each location has its own specific context. For example, a transmission line that carries voltage from location A to B might require a different maintenance schedule and can have different physical requirements such as the acceptable level of tension for the weather conditions. Similarly, a conveyor belt may have a different maintenance schedule and requirements based on the carrying weights and volume metrics. Therefore, it is important to understand the asset, its components, and the hierarchy managing the asset within the corresponding operational context

Centralized asset library and asset management can be difficult to maintain for many industries due to the challenge in collecting, creating, inserting new assets, and deleting the obsolete assets. Further difficulty can be encountered due to the lack of domain experts and assets corresponding digital content for the meta information and relationship between the hierarchical components. Centralized asset library and asset management can present all the information regarding an asset in a unified manner such as electrical systems on the factory floor and the locations of electrical panels, or type of insulation used for the electrical system. The combination of a variety of information can assist in operational maintenance and product improvement for a sustainability engineer.

### SUMMARY

Legacy industries may improve the operational performance by creating and maintaining the digital inventory of a multitude of assets. The additional effort of the legacy industry to move to the digital inventory methodologies can save time and effort in the long run.

There is an abundance of unstructured data available which contain asset hierarchical information. However, the capture, conversion, and categorization of such unstructured data is challenging in an automated and economic way. Categorizing assets by context is a laborious task and dissipating context aware information is critical for complex system operations. The manual categorization is prone to human error, which can get propagated to all of the downstream pipelines.

In the related art, the addition of the new assets to the digital library is a manual process and does not contain the context information. To address such issues, the example implementations described herein are directed to the automatic discovery of the asset hierarchy, and asset relationships along with the context. Further, the example implementations described herein can facilitate the fusion of the information about the data through multiple sources, and the multiple sensors ensure the updated and accurate information.

Example implementations described herein can involve systems and methods for using images and image related data to create the asset hierarchy. In an aspect, the systems and methods described herein can use the object detection model to identify the assets and the create asset hierarchy from the detected assets and their corresponding bounding boxes.

Example implementations described herein can involve systems and methods for novel data discovery. In an aspect, the systems and methods described herein can discover the desired images from the disordered bucket through the trained network. In another aspect, the systems and methods described herein can use images to discover the accurate context for precise image asset hierarchy. In another aspect, the systems and methods described herein can make use of multiple models in tandem to reduce the errors in asset hierarchy discovery. In another aspect, the systems and methods described herein allow for the identification of the characteristics of the assets in a physical system, as well as the use of multiple sources to generate the relationships between assets.

Example implementations described herein can involve systems and methods for asset hierarchy template creation. In an aspect, a generic asset hierarchy template is discovered based on the unordered images coming from many different data sources. In an aspect, systems and methods described herein can use annotation boxes as well as constrained frequent pattern mining algorithms and informed pruning methods to not only identify the parent-child relationships, but also identify sibling relationships as well. Example implementations described herein can involve using mathematical models to identify the frequent relationships to reduce the discovery of the inaccurate relationships. Through the example implementations described herein, the systems and methods can allow streamlined feedback from the subject matter expert (SME), allow the discovery of the new relationships, understand the relationship between assets and categorizing them (e.g., Strong vs. weak relationships), as well as identify the parent assets in the parent child relationship.

Example implementations described herein can involve systems and methods to facilitate asset hierarchy discovery. In an aspect, the systems and methods described herein can use the data coming from a single data source (e.g. data from a single company only) to identify the accurate asset hierarchy. In another aspect, the systems and methods described herein can use the asset hierarchy template to identify the potential missing hierarchical assets and add them to the hierarchy. Further, the systems and methods described herein can also allow for accumulation of the data for the easy asset management and in a JavaScript Object Notation (JSON) format, or another format as desired.

Aspects of the present disclosure can involve a method for generating an asset hierarchy from a plurality of images of a plurality of assets, the method involving executing a machine learning process to identify the plurality of assets from the plurality of images; identifying relationships between the identified plurality of assets based on feature extraction and analysis of extracted features of the identified plurality of assets; and generating the asset hierarchy from one or more asset hierarchy templates derived from the identified relationships between the identified plurality of assets.

Aspects of the present disclosure can involve a computer program having instructions for generating an asset hierarchy from a plurality of images of a plurality of assets, the computer program involving executing a machine learning process to identify the plurality of assets from the plurality of images; identifying relationships between the identified plurality of assets based on feature extraction and analysis of extracted features of the identified plurality of assets; and generating the asset hierarchy from one or more asset hierarchy templates derived from the identified relationships between the identified plurality of assets. The computer program and instructions can be stored on a non-transitory computer readable medium and executed by one or more processors.

Aspects of the present disclosure can involve a system for generating an asset hierarchy from a plurality of images of a plurality of assets, the system involving means for executing a machine learning process to identify the plurality of assets from the plurality of images; means for identifying relationships between the identified plurality of assets based on feature extraction and analysis of extracted features of the identified plurality of assets; and means for generating the asset hierarchy from one or more asset hierarchy templates derived from the identified relationships between the identified plurality of assets.

Aspects of the present disclosure can involve an apparatus configured to generate an asset hierarchy from a plurality of images of a plurality of assets, the apparatus involving a processor, configured to execute a machine learning process to identify the plurality of assets from the plurality of images; identify relationships between the identified plurality of assets based on feature extraction and analysis of extracted features of the identified plurality of assets; and generate the asset hierarchy from one or more asset hierarchy templates derived from the identified relationships between the identified plurality of assets.

### BRIEF DESCRIPTION OF THE DRAWINGS

FIG. 1 illustrates an example of the asset hierarchy discovery process, in accordance with an example implementation.

FIG. 2 illustrates an example of the data discovery, in accordance with an example implementation.

FIG. 3 illustrates an example of the context discovery, in accordance with an example implementation.

FIG. 4 illustrates an example of the annotation box locations, in accordance with an example implementation.

FIG. 5 illustrates an example process of the asset hierarchy creation pipeline, in accordance with an example implementation.

FIG. 6 illustrates an example computing environment with an example computer device suitable for use in some example implementations.

FIG. 7 illustrates an example output of the asset hierarchy derived from the asset hierarchy templates, in accordance with an example implementation.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Obtaining an asset hierarchy for a legacy system can be important for facilitating data analytics, because the asset hierarchy directly influences the assets in scope. The assets in scope can be linked to the other assets in the subsystem through the asset hierarchy. From the linking of the subsystem, failure modes can be analyzed and the corresponding analytics can thereby be performed. Although example implementations described herein are provided in relation to the field of electrical tower transmission and distribution, other fields to which asset hierarchy can be applied (e.g., manufacturing, factory floors, Internet of Things (IoT) systems, etc.) in accordance with the desired implementation, and the present disclosure is not limited thereto.

In examples in which there may be a new equipment update or the decommission of the equipment, it can be difficult to cohesively manage the asset library or the asset hierarchy. Through the example implementations described herein, the system itself can provide the most accurate up to date current information as well as eliminate non-related information. In the related art, the categorization of these assets can be very time consuming and manually intensive maintain.

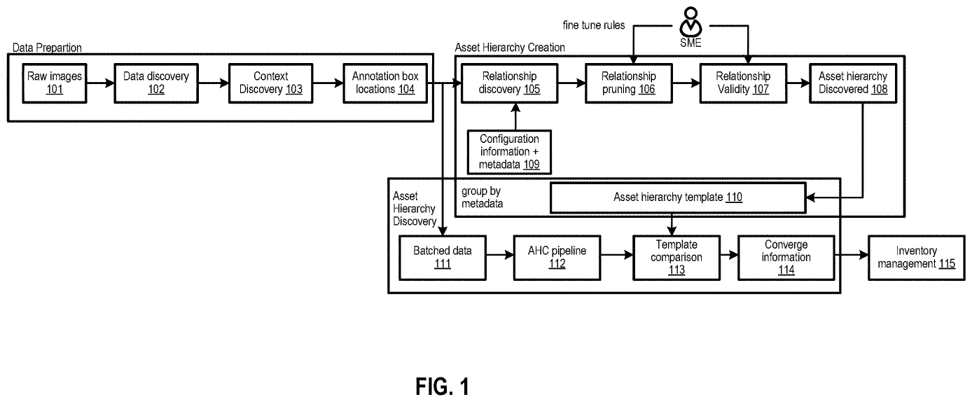

FIG. 1 illustrates an example of the asset hierarchy discovery process, in accordance with an example implementation. As illustrated in FIG. 1, the processing of the asset hierarchy discovery is split into three stages.

In the data preparation process, the data can be accumulated from multiple sources and can be unordered. For example, while mining images for transmission lines, it may find images that are hazy, poor in quality and/or have no desired asset present in them. Such images can be stored locally in a device or server from manually captured images, can be streamed from a camera or drone, or otherwise in accordance with the desired implementation. The images may be related to the domain (transmission line) or they may not be.

In an example implementation involving high voltage lines, images may be provided from drones and then they can have images of similar looking distribution lines and substations. However, some of the substations may be old and providing low voltage, whereas others may have transmission line images with high voltage but not related substations. Thus, the transmission lines may have completely different assets underlying them, although they appear to be similar to distribution lines.

To address such issues, a model is used to extract features from the images and analyze the images in context to determine their appropriate domain and context through the data discovery process as follows. To run the asset hierarchy, the first step is to clean the data and find the data that is relevant to the system of the desired asset hierarchy to be detected. At first, raw images 101 are taken as an input and then data is passed through the data discovery 102 that identifies the data of interest based on a trained model-this stage allows the filtration of the desired data from a generic data bucket. The images are further classified with their contexts by the context discovery 103 to allow the accurate creation of the asset hierarchy. The annotation boxes are created for the detected assets with the annotation box locations 104. The images and associated metadata along with the annotation boxes and their labels are then ready for the discovery of the asset hierarchy.

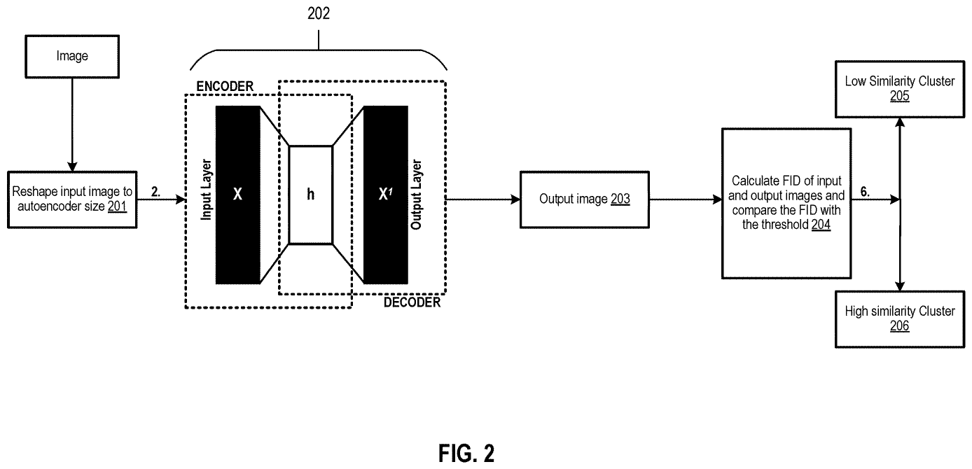

FIG. 2 illustrates an example of the data discovery 102, in accordance with an example implementation. The data discovery 102 involves an autoencoder that is trained with the sample images that are part of the system of the asset hierarchy to be discovered. A trained autoencoder learns the latent representation of the images it was trained on, takes an image as input and based attempts to recreate the image based on the learned latent representation. If the input images belong to the same type of the images that the network was trained on, the output image will be similar to the input image. Conversely, if the image does not belong to the same type of the images that the network was trained on, the output image will be substantially different than the input.

In the example involving distribution lines versus transmission lines, separate groups of images are used (e.g., from historical database, from labeled data from data analysts, etc.) to train an autoencoder. The autoencoder can create representations of the images for comparison, so as to determine what kind of image belongs to what kind of domain. The autoencoder can be trained with images known to be of a particular group in accordance with the desired implementation (e.g., power lines and various components of the power system, assets in a factory etc.) At 201, the image received as input (e.g., raw images 101) is resized to match with the input requirements of the trained autoencoder (e.g., the size is based on the images that the autoencoder is trained on). Such an image is then input to the autoencoder as X at 202. The encoder will then output image X′ as the output image 203.

At 204, the process calculates the Frenchet Inception Distance (FID) scores of the X and X′ to identify how similar they are, and compares the calculated FID with a predetermined threshold set in accordance with the desired implementation. If the FID is greater than the threshold, then the image is added to the low similarity cluster 205. If the FID is less than the threshold, then the image is added to the high similarity cluster 206. The high similarity cluster 206 contains the images determined to be similar to the images used to train the autoencoder. The lower the FID score, the higher is the image similarity.

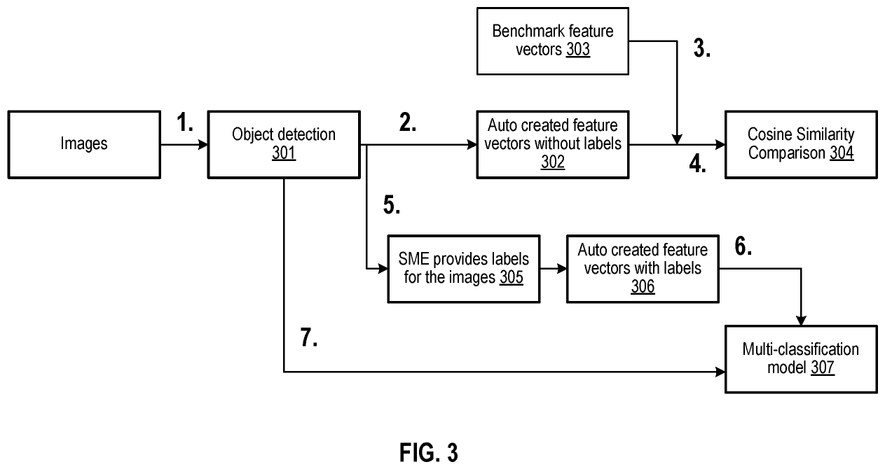

FIG. 3 illustrates an example of the context discovery 103, in accordance with an example implementation. Once the images are processed and the object detection/data discovery is conducted, feature vectors can be formed for all the components of the images to conduct context discovery. For example, in a particular image for a power system, there can be components such as insulator, electrical tower, and so on. The feature vectors indicate, for each image, the group of components that can be involved. Such feature vectors can be used to determine the commonality of the assets, and can be constructed in accordance with the desired implementation.

At first, images are passed through a trained object detection model 301 to discover the assets. At 302, the feature vectors are then automatically created from the discovered assets, and is done without labels. If available, the SME can provide benchmark feature vectors for desired classes as shown at 303. At 304, the process uses the cosine similarity to associate the created feature vectors to a particular class.

Another way the context can be discovered is by allowing the SME to provide context for each image and to create the feature vectors with the class labels as shown at 305, which is used to auto create feature vectors with labels as shown at 306. At 307, a multi-classification machine learning model is trained to discover the context.

From the context discovery and pre-defined association rules, the relationships can be built and the strength of the relationships can be determined. The relationships can be based on the how much the images appears with each other. Further, missing relationships can be detected through the proposed example implementations based.

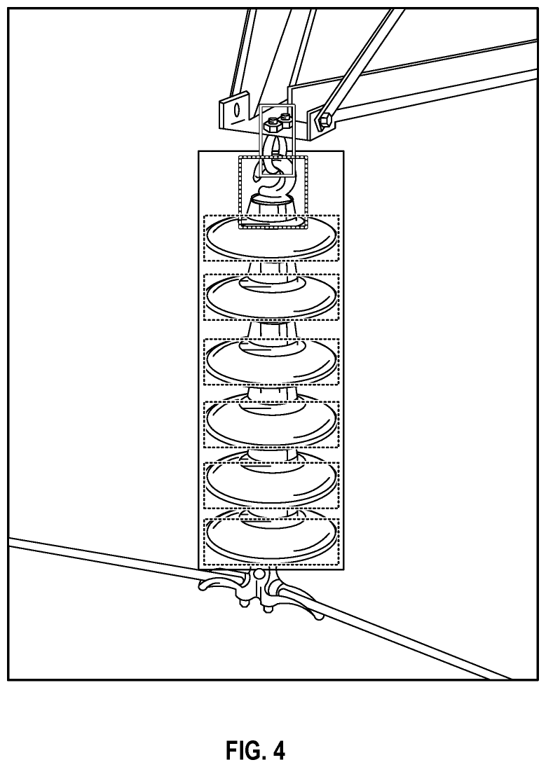

FIG. 4 illustrates an example of the annotation box locations 104, in accordance with an example implementation. After executing object detection model 301, the bounding boxes of the detected objects can be determined. Such bounding boxes represent the detection of the component, or a defect on the object. Further, the model output can be used to discover the correct context by passing it through the trained multi-classification mode. The example of FIG. 4 illustrates that the insulator bounding box fully contains the bounding box for the top hook and the discs. Such bounding boxes can assist in creating the itemset for the detection of the asset hierarchy.

In the example of FIG. 4, there are bounding boxes annotated on the images which involves bounding boxes for the insulator and the discs. The bounding boxes for the discs are enclosed within other bounding boxes. Such relationships can be captured in a feature vector that relates each of these subcomponents together, along with their positioning relationship. Other relationships can be related to each other based on the overlap of the boxes.

With regards to the asset hierarchy creation process of FIG. 1, once the data has been identified and cleaned, the next step is to identify all of the possible assets and create a comprehensive asset hierarchy template with the help of those identified assets and their corresponding positions to each other. The captured assets can be sorted based on domain based on the detected bounding boxes and the model. The asset hierarchy template is created so that the relationships between each asset (e.g., relationship between conductor and tower, or conductor and insulator, etc.). There are different aspects of the assets that can be decomposed into subcomponents to determine their relationships. The relationships between components inside of each image can be built and the strength of each relationship can be examined.

The annotation boxes are created for the detected assets and then passed to Asset Hierarchy Creation. The Asset Hierarchy Creation (AHC) pipeline is used at the beginning of asset hierarchy discovery and collection, where the first step is to execute a relationship discovery process which uses the bounding boxes (along with any configuration information or metadata 109) to identify which asset contains the complete bounding box of the other asset. Then, by using pattern mining, the association rules between the parent and child elements are discovered by the relationship discovery process 105.

Subsequently, relationship pruning 106 utilizes pruning rules so that the association rules are further filtered and only the association rules which satisfy the criteria are kept. The SME can also continue to finetune the rules as and if needed in accordance with the desired implementation. Further, should such an implementation be desired, the SME can further validate the relationships at 107. In an example of relationship pruning 106, child assets cannot have more than one parent asset. children cannot have more than one parent. Thus, a large portion of the pruning is conducted not only on the relationship, but also based on the structure of the hierarchy.

Finally, all of the discovered relationships 108 along with additional metadata details are added to the asset hierarchy template 110.

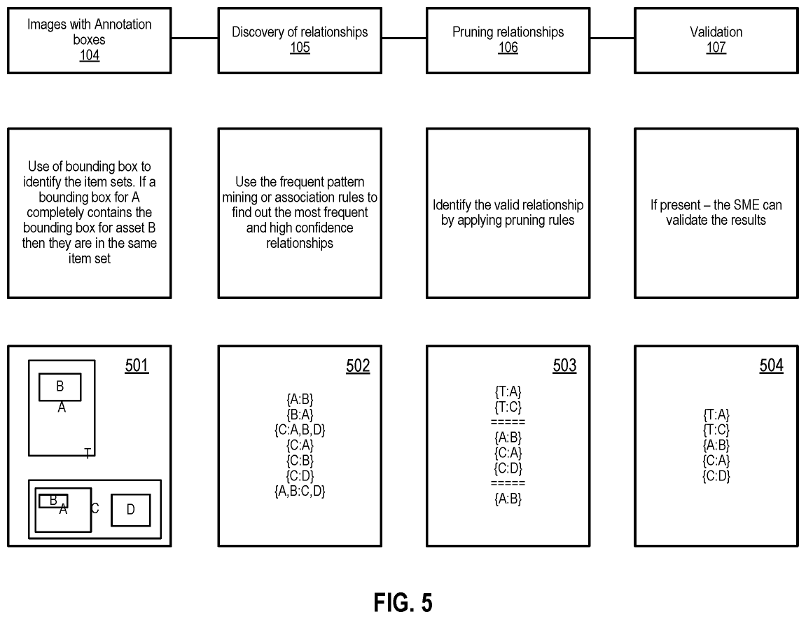

FIG. 5 illustrates an example process of the asset hierarchy creation pipeline, in accordance with an example implementation. Rules identified for pruning the discovered associated relationships from the image data can involve the following, but can be modified in accordance with the desired implementation.
1) The left-hand-side (LHS) of association rules should have only one element.
2) There should only be one to one matching between the assets, one LHS element to one right hand-side (RHS) element of association rules.
3) The bounding box of the LHS element is bigger than the elements on the RHS.
4) An asset cannot have two parents-if one of the parents is already a child of the other parent, remove that from the parent list.

In an example processing according to the asset hierarchy creation pipeline, for image 501 with annotated bounding boxes, the bounding boxes are used to identify the item sets. Each asset is given an asset identifier (asset ID) as illustrated in FIG. 5, which can be provided from configuration information and metadata 109. In this example, the asset IDs are given simple letters (A, B, C, D, T) for explanation purposes, but can be set otherwise in accordance with the desired implementation. If a bounding box for asset A completely contains the bounding box for asset B, then those assets are considered to be in the same item set. In an example of the discovery of relationships 105, the frequent pattern mining or association rules are used to find out the most frequent and high confidence relationships, which are indicated at 502. From the example annotated image 501, the relationships relating asset A to B, from asset B to A, relating asset C to assets A, B, and D individually and as a group, and the relationship of assets A and B to assets C and D are derived as shown at 502, but is not exhaustive.

Subsequently, to prune the relationships at 106, the valid relationship is identified by applying pruning rules as described above. In this example, the relationship for asset T is determined to be the parent of asset A and asset C. Other relationships that are determined is that asset A is the parent of asset B, asset C is a parent of asset A and asset D, and the other multiple relationships (e.g. due to multiple parents) are removed, with the resulting pruned relationships illustrated at 503. The relationships can then be validated which can result in the validated relationships illustrated at 504, which can be used as an asset hierarchy template 110.

The process illustrated in FIG. 5 is reiterated as each new image is processed, and the asset hierarchy templates 110 that are generated can then be used to generate the asset hierarchy as described herein.

With respect to the Asset Hierarchy Discovery (AHD) of FIG. 1, the last step is to detect a source specific asset hierarchy with the help of the images obtained from a specific source. However, the information may not be completed and thus the asset hierarchy template to find the missing pieces and supplement the asset hierarchy information.

Once the asset hierarchy data template 110 is discovered, the live data is passed to Asset Hierarchy Discovery (AHD). Asset Hierarchy Discovery (AHD) batches the data into batched data 111, which involves sections of related images with the help of metadata. The AHC pipeline 112 is executed on batched data and the asset hierarchy and relationships are discovered from that batched data, and executes the flow illustrated from 105 to 109.

Once the asset hierarchy is created, it is matched with the template for validation through template comparison 113. Some assets may be missed in the batched data asset identification, thus the template created in AHC is used to identify the missing assets. The underlying principle is that if the child is present, so then the parent should be as well. Thus, the template comparison 113 is used to fill the gaps of where the parent is not found in the batched data, but will skip adding any of the child not found in the data.

The information contained in template and the asset hierarchy is converged into converge information 114 and is then added to the inventory management system 115. The converge information 114 is based on the information determined from the template. For example, there can be multiple templates that are applied (e.g., historical templates as well as the derived template for the transmission line) can be compared for converge information 114.

In example implementations, there can be a power system that involves a large number of power towers (e.g., over 10000) which are imaged through using cameras (e.g., either from posted cameras or from manually captured images from physical locations), as well as drones. Such towers can be mapped by physical location, and then, through the example implementations described herein, the systems and methods can capture not only the relationship between the assets, but the number of assets, the associated components/subcomponents, their relationships, and so on. Such a result would not be possible without time consuming manual analysis and may not be possible at all to conduct manually depending on the number of assets in question. Further, for systems such as transmission lines or power systems, the processing of such captured images would incur a high risk of error propagation if done manually.

In an example iteration involving the power system as described above, such power systems are imaged either from images captured from a tower, or images captured from a drone. Such images can be sorted and pre-processed to separate the images captured from the tower and the images captured from the drone (e.g., based on image metadata). Asset hierarchy templates can then be learned through the processes described in FIGS. 1 to 5 to generate templates based on the images captured from the tower, and separate asset hierarchy templates are learned for the images captured from the drone. The asset hierarchy can then be constructed from a union of the template for the images captured from the tower and the images captured from a drone through converge information 114.

Through the example implementations described herein, it is therefore possible to allow legacy industries to transition to the digital inventory and a hierarchy creation approach by mitigating the laborious task of manual transformation. The example implementations described herein can facilitate an automated and effective way to capture, convert and categorize the abundantly available unstructured image data to hierarchical data (e.g., in JSON or YAML). Example implementations described herein reduce the prospect of human error and error propagation in the manual categorization by automatically categorizing assets context and sharing structural, behavior and failure mode information to all the relevant systems.

The example implementations further involve allow automated discovery of assets that allows accurate and updated information reflection of the asset hierarchy of the system. The example implementations further compound discovery of the asset, asset hierarchy and asset relationship, which allows for the cohesive calculation of the health of the assets.

The example implementations further ensure industrial stability and sustainability by allowing continued monitoring of the assets and the impact from the cascade failures from other sub-assets, as well as allow for the usage of the disordered bucket to identify images of interest, which can facilitate easy categorization of the unstructured data.

The example implementations further allow for the capturing of the unstructured data from multiple sources and presents in a single cohesive format. The example implementations can provide a foundation to track individual assets and standardization of asset hierarchy template.

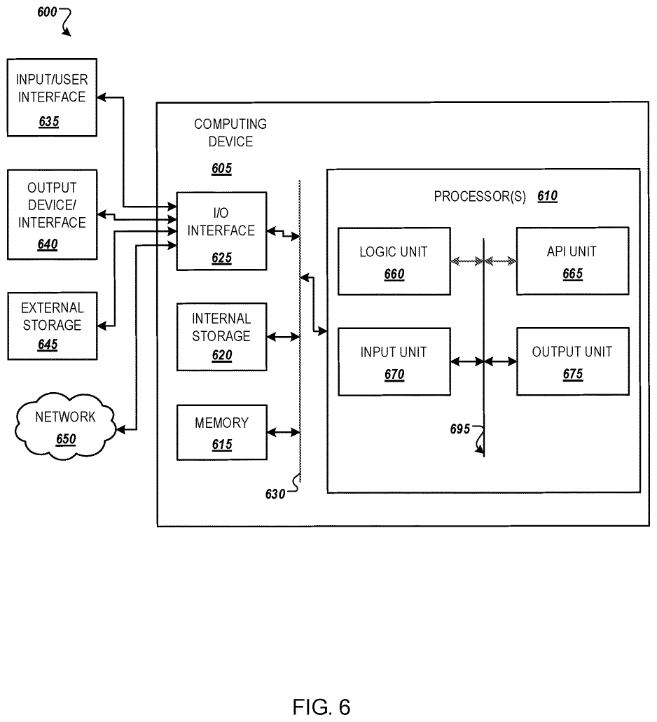

FIG. 6 illustrates an example computing environment with an example computer device suitable for use in some example implementations. Computer device 605 in computing environment 600 can include one or more processing units, cores, or processors 610, memory 615 (e.g., RAM, ROM, and/or the like), internal storage 620 (e.g., magnetic, optical, solid-state storage, and/or organic), and/or IO interface 625, any of which can be coupled on a communication mechanism or bus 630 for communicating information or embedded in the computer device 605. IO interface 625 is also configured to receive images from cameras or provide images to projectors or displays, depending on the desired implementation.

Computer device 605 can be communicatively coupled to input/user interface 635 and output device/interface 640. Either one or both of the input/user interface 635 and output device/interface 640 can be a wired or wireless interface and can be detachable. Input/user interface 635 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 640 may include a display, television, monitor, printer, speaker, braille, or the like. In some example implementations, input/user interface 635 and output device/interface 640 can be embedded with or physically coupled to the computer device 605. In other example implementations, other computer devices may function as or provide the functions of input/user interface 635 and output device/interface 640 for a computer device 605.

Examples of computer device 605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 605 can be communicatively coupled (e.g., via IO interface 625) to external storage 645 and network 650 for communicating with any number of networked components, devices, and systems, including one or more computer devices of the same or different configuration. Computer device 605 or any connected computer device can be functioning as, providing services of, or referred to as a server, client, thin server, general machine, special-purpose machine, or another label.

IO interface 625 can include, but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 600. Network 650 can be any network or combination of networks (e.g., the Internet, local area network, wide area network, a telephonic network, a cellular network, satellite network, and the like).

Computer device 605 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 605 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 610 can execute under any operating system (OS) (not shown), in a native or virtual environment. One or more applications can be deployed that include logic unit 660, application programming interface (API) unit 665, input unit 670, output unit 675, and inter-unit communication mechanism 695 for the different units to communicate with each other, with the OS, and with other applications (not shown). The described units and elements can be varied in design, function, configuration, or implementation and are not limited to the descriptions provided. Processor(s) 610 can be in the form of hardware processors such as central processing units (CPUs) or in a combination of hardware and software units.

In some example implementations, when information or an execution instruction is received by API unit 665, it may be communicated to one or more other units (e.g., logic unit 660, input unit 670, output unit 675). In some instances, logic unit 660 may be configured to control the information flow among the units and direct the services provided by API unit 665, the input unit 670, the output unit 675, in some example implementations described above. For example, the flow of one or more processes or implementations may be controlled by logic unit 660 alone or in conjunction with API unit 665. The input unit 670 may be configured to obtain input for the calculations described in the example implementations, and the output unit 675 may be configured to provide an output based on the calculations described in example

### Implementations.

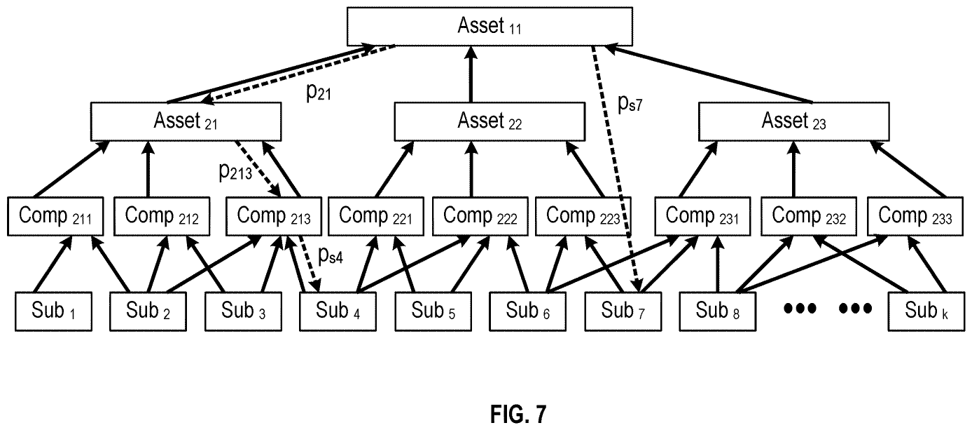

£ Processor(s) 610 can be configured to execute a method or instructions for generating an asset hierarchy from a plurality of images of a plurality of assets (as shown from raw images 101 to data discovery 102), which can involve executing a machine learning process (e.g., such as autoencoder 202 illustrated in FIG. 3) to identify the plurality of assets from the plurality of images; identifying relationships between the identified plurality of assets based on feature extraction and analysis of extracted features of the identified plurality of assets as described with respect to relationship discovery 105; and generating the asset hierarchy (e.g., as illustrated in FIG. 7) from one or more asset hierarchy templates derived from the identified relationships between the identified plurality of assets (e.g., as illustrated with respect to asset hierarchy template 110 and example validated relationship 504).

Processor(s) 610 can be configured to execute the method or instructions as described above, and further involve executing an autoencoder on raw images to generate output images as illustrated in FIG. 3, the autoencoder trained against assets images of a particular domain 201 and configured to generate output images 203 that are recreations of the raw images in new domains; and filtering out the raw images to form the plurality of images based on similarity of the output images and the raw images meeting a threshold as illustrated at 204 to 206.

Processor(s) 610 can be configured to execute the method or instructions as described above, wherein the machine learning process is configured to generate bounding boxes on the identified plurality of assets as illustrated in 103 and 104 of FIG. 1, and in the examples of FIG. 4 and annotated image 501 of FIG. 5.

Processor(s) 610 can be configured to execute the method or instructions as described above, wherein the identifying the relationships between the identified plurality of assets based on feature extraction and analysis of extracted features of the identified plurality of assets can involve generating annotation boxes that identify ones of bounding boxes of the identified plurality of assets that are encapsulated within other ones of the bounding boxes of the identified plurality of assets; executing a relationship discovery process to identify potential relationships; identify the relationships from the potential relationships through an execution of pruning rules; and receiving validation on the identified relationships as illustrated in FIG. 5. In example implementations, the relationship discovery process can involve the processing of pre-defined association rules or frequent pattern mining as described herein.

Processor(s) 610 can be configured to execute the method or instructions as described above, wherein the generating the asset hierarchy from the one or more asset hierarchy templates derived from the identified relationships between the identified plurality of assets involves generating a first asset hierarchy template derived from the identified relationships between the identified plurality of assets associated with a first set of images from the plurality of images captured by drone; generating a second asset hierarchy template derived from the identified relationships between the identified plurality of assets associated with a second set of images from the plurality of images captured from a tower; and generating the asset hierarchy from a union of the first asset hierarchy template and the second asset hierarchy template.

Processor(s) 610 can be configured to execute the method or instructions as described above, wherein each of the plurality of images are associated with an asset ID; wherein the method or instructions further involve updating the asset hierarchy and asset metadata in response to additional images as illustrated in FIG. 5 and FIG. 7.

FIG. 7 illustrates an example output of the asset hierarchy derived from the asset hierarchy templates, in accordance with an example implementation. Through the example implementations described herein, raw images of legacy systems can be processed to determine the asset hierarchy of the system of interest, including parent/child relationships of assets, components (Comp) of assets, and subcomponents (Sub) of assets. Each of these assets, components, and subcomponents are given an asset identifier (e.g., Asset 11, Asset 23, etc.) which can be updated with each iteration of images that are received.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for generating an asset hierarchy from a plurality of images of a plurality of assets, the method comprising:
executing a machine learning process to identify the plurality of assets from the plurality of images;
identifying relationships between the identified plurality of assets based on feature extraction and analysis of extracted features of the identified plurality of assets; and
generating the asset hierarchy from one or more asset hierarchy templates derived from the identified relationships between the identified plurality of assets.

2. The method of claim 1, further comprising:
executing an autoencoder on raw images to generate output images, the autoencoder trained against assets images of a particular domain and configured to generate output images that are recreations of the raw images in new domains; and
filtering out the raw images to form the plurality of images based on similarity of the output images and the raw images meeting a threshold.

3. The method of claim 1, wherein the machine learning process is configured to generate bounding boxes on the identified plurality of assets.

4. The method of claim 1, wherein identifying the relationships between the identified plurality of assets based on feature extraction and analysis of extracted features of the identified plurality of assets comprises:
generating annotation boxes that identify ones of bounding boxes of the identified plurality of assets that are encapsulated within other ones of the bounding boxes of the identified plurality of assets;
executing a relationship discovery process to identify potential relationships;
identify the relationships from the potential relationships through an execution of pruning rules; and
receiving validation on the identified relationships.

5. The method of claim 1, wherein the generating the asset hierarchy from the one or more asset hierarchy templates derived from the identified relationships between the identified plurality of assets comprises:
generating a first asset hierarchy template derived from the identified relationships between the identified plurality of assets associated with a first set of images from the plurality of images captured by drone;
generating a second asset hierarchy template derived from the identified relationships between the identified plurality of assets associated with a second set of images from the plurality of images captured from a tower; and
generating the asset hierarchy from a union of the first asset hierarchy template and the second asset hierarchy template.

6. The method of claim 1, wherein each of the plurality of images are associated with an asset ID;
wherein the method further comprises updating the asset hierarchy and asset metadata in response to additional images.

7. A non-transitory computer readable medium, storing instructions for generating an asset hierarchy from a plurality of images of a plurality of assets, the instructions comprising:
executing a machine learning process to identify the plurality of assets from the plurality of images;
identifying relationships between the identified plurality of assets based on feature extraction and analysis of extracted features of the identified plurality of assets; and
generating the asset hierarchy from one or more asset hierarchy templates derived from the identified relationships between the identified plurality of assets.

8. The non-transitory computer readable medium of claim 7, the instructions further comprising:
executing an autoencoder on raw images to generate output images, the autoencoder trained against assets images of a particular domain and configured to generate output images that are recreations of the raw images in new domains; and
filtering out the raw images to form the plurality of images based on similarity of the output images and the raw images meeting a threshold.

9. The non-transitory computer readable medium of claim 7, wherein the machine learning process is configured to generate bounding boxes on the identified plurality of assets.

10. The non-transitory computer readable medium of claim 7, wherein the identifying the relationships between the identified plurality of assets based on feature extraction and analysis of extracted features of the identified plurality of assets comprises:
generating annotation boxes that identify ones of bounding boxes of the identified plurality of assets that are encapsulated within other ones of the bounding boxes of the identified plurality of assets;
executing a relationship discovery process to identify potential relationships;
identifying the relationships from the potential relationships through an execution of pruning rules; and
receiving validation on the identified relationships.

11. The non-transitory computer readable medium of claim 7, wherein the generating the asset hierarchy from the one or more asset hierarchy templates derived from the identified relationships between the identified plurality of assets comprises:
generating a first asset hierarchy template derived from the identified relationships between the identified plurality of assets associated with a first set of images from the plurality of images captured by drone;
generating a second asset hierarchy template derived from the identified relationships between the identified plurality of assets associated with a second set of images from the plurality of images captured from a tower; and
generating the asset hierarchy from a union of the first asset hierarchy template and the second asset hierarchy template.

12. The non-transitory computer readable medium of claim 7, wherein each of the plurality of images are associated with an asset identifier;
wherein the instructions further comprises updating the asset hierarchy and asset metadata in response to additional images.

13. An apparatus configured to generate an asset hierarchy from a plurality of images of a plurality of assets, the apparatus comprising:
a processor, configured to:
execute a machine learning process to identify the plurality of assets from the plurality of images;
identify relationships between the identified plurality of assets based on feature extraction and analysis of extracted features of the identified plurality of assets; and
generate the asset hierarchy from one or more asset hierarchy templates derived from the identified relationships between the identified plurality of assets.
